(19) United States
(12) Patent Application Publication
(10) Pub. No.: US 2020/0265164 A1
(43) Pub. Date: Aug. 20, 2020

(54) ARCHITECTURE AND METHOD FOR TRACKING AND MANAGING DIGITAL DATA

(71) Applicant: Silvio SILIPRANDI, Milano (IT)

(72) Inventor: Silvio SILIPRANDI, Milano (IT)

(21) Appl. No.: 16/649,308

(22) PCT Filed: Sep. 20, 2018
(86) PCT No.: PCT/IT2018/050171

§ 371 Date: Mar. 20, 2020

(30) Foreign Application Priority Data
Sep. 21, 2017 (IT) 102017000105662

(51) Int. Cl. G06F 21/62; G06F 21/60; H04L 29/06; G06Q 50/26; G06Q 30/02; G06Q 50/00

(52) U.S. Cl. CPC G06F 21/6263; G06F 21/602; H04L 63/0428; H04L 43/50; G06Q 30/0203; G06Q 50/01; G06F 2221/0704; G06Q 50/265

(57) ABSTRACT

Architecture for tracking and managing digital data includes at least one app or interface configured to be loaded on a browsing device for tracking and managing the digital data transmitted by one or more of said browsing devices; at least one automatic data revendication app supporting the previous function; at least one management platform having a centralized server able to receive the transmitted digital data; at least one memory system to memorize the digital data, able to communicate with the centralized server and the browsing devices and to collect, organize, protect and make anonymous the digital data, and also to file and reconstruct the chronology or digital life of one or more users, each user being enabled to access the architecture and his/her own digital life using the respective browsing device through said interface; and at least a data masking app operatively communicating with said management platform and said interface.

### FIELD OF THE INVENTION

The present invention concerns a method and architecture for tracking and managing digital data.

In particular, the present invention concerns an architecture and a method for tracking, memorizing and protecting data which is able to guarantee to each user of the World Wide Web (hereafter web) security, privacy and the possibility to reconstruct, valorize and modify his/her “digital life”, that is to say, for example, the activities carried out on the web in a given period of time, or other actions, for example purchases and choices, which can take place outside the web but that are encoded and memorized in digital tracks (data) referring to the individual.

The term “digital data” means, for example, data released knowingly or unknowingly during normal web browsing, for example, user identification data or other personal data, or data relating to the preferences, interests or tastes of the user, or data relating to search activities, to purchase choices, completed with electronic systems or otherwise electronically encoded (for example loyalty cards), use of services and energy (for example utilities), financial or insurance characterizations, or other data and characterizations referable to the individual that have electronic codes in archives, native—created during browsing—or after any act, even offline.

### BACKGROUND OF THE INVENTION

As is known, during normal web browsing, using any suitable browser device, for example a smartphone, a tablet, a personal computer or suchlike, the data generated and transmitted by each individual are substantially taken from the user and used by third parties for their own benefit, consider for example so-called “cookies”.

In other words, each user of the web is subjected to tracking and, with browsing but also with his/her interactions, releases choices, purchases, etc.—also unknowingly and also with off-line digitalized behaviors—data that are the subject of a thriving market, typically for advertising purposes, of which, however, none of us has had, so far, a direct economic return, even minimal.

Furthermore, the security and privacy of the data transmitted or stored relating to the user is not always guaranteed in an optimal way and moreover, as is also known, it is extremely difficult, if not impossible, to reconstruct one's “digital life”, that is, that set of activities—translated into digital data—that each user performs on the web when connecting to sites, service providers or other, or releases as an effect of his/her choices and interactions also off-line, later encoded and organized into electronic archives by suppliers/companies and then normally merged and integrated—or integrable—with the digital data collected via the web. By “digital life” we therefore also mean the set of information, preferences and in general digital data—native or digitized at a later time—collected in databases, referring to the individual, integrated or integrable with each other, that each user, even unknowingly, releases onto the web or off-line due to his/her interactions, behaviors, searches and choices.

One problem that derives from the impossibility of establishing digital data accurately, and possibly modifying them, is that said data can also be redundant and their distribution and management by the servers and/or users themselves will be inefficient and ultimately rather complex.

Another big problem of current web browsing and, more generally, of the digitization of data referring to people, is also the value of their privacy and the need to protect it, even more so in the digital environment and, more generally, in the era of Big Data where we have started to live. The repeated and growing alarms in this area and the increasing activity of legislation and restriction in this field, bring with them, for many people, an increase in the awareness of how sensitive the issue of privacy is, and the awareness, on the part of the individual, of a new need to protect and respect what is “private”—in our case, data and what they can say about us—especially considering that it has now become clear how, through data and their integration, on many sides and in many fields of action—on the level of companies and supra-individual entities, all characterized by the availability of data relating to individuals—attempts are being made to influence the opinions and choices of citizens-consumers.

Other limitations and disadvantages of conventional solutions and technologies will be clear to a person of skill after reading the remaining part of the present description with reference to the drawings and the description of the embodiments that follow, although it is clear that the description of the state of the art connected to the present description must not be considered an admission that what is described here is already known from the state of the prior art.

There is therefore a need to perfect an architecture and a method for tracking and managing digital data, in particular tracking, memorizing and protecting data that can overcome at least one of the disadvantages of the state of the art. In particular, an architecture that is unquestionably and unconditionally on the side of the citizen-consumer, providing him/her with innovative tools and a comprehensive architecture able to give him/her availability, management skills, protection, investment, proactivity, privacy and a leading role, in terms of data, which at the moment have no equal.

One purpose of the present invention is therefore to create an architecture for tracking and managing digital data that allows each user to be able to collect their digital data, in parallel to normal web browsing and not only, from a server that allows security and protection of privacy, to file and reconstruct an exact, modifiable and consultable chronology of digital life, which allows the user to valorize their data and also which is a database able to apply blockchain technology and Artificial Intelligence, to be used to protect and facilitate the user in analyzing market opportunities and in closing smart contracts.

Another purpose of the invention is an architecture for tracking and managing data that is able to collect, on a voluntary basis, the data of the subscribers, creating a community, investing them in the data market and sharing economic returns, through three forms of participation in the economic return: direct payment by the companies interested in the contact (anonymous, protected and brokered by the manager of the community) with the member, for the proposition of personalized offers and business opportunities; individual enjoyment of said commercial proposals and highly personalized, and therefore more valuable opportunities; participation in large-scale prize draws for all members of the community generated by the architecture.

In one aspect of the invention, therefore, the present architecture is fundamentally based on the conscious “voluntary disclosure” of the data through forms of legal proxy to the manager of the architectural platform, as well as on the accumulation of the data in interesting quantities and qualities that can be used in the market, through intermediation and a proactive activity by the manager himself and able to produce for the individual all the economic, technological and protection advantages, as described above.

In particular, another purpose of the invention is to provide a method and an architecture for managing digital data in which the data can be used only in an anonymous form. In addition to the minimum level of data “disclosure”, essential for becoming part of the architecture, the user can autonomously decide to invest other data in the community created by the architecture, increasingly and at different levels of width/spectrum and depth. The community guarantees, through a special algorithm, an increase in the probabilities, for the individual, of benefitting from the economic return proportional to the quantity and quality/value of the data “invested” in the community: the more data one invests, the greater the probability of benefitting from the economic return. Participating in the community created by this architecture is free, except for possible forms of crowdfunding, always on a voluntary and aware basis, for specific sub-projects.

Another purpose of the invention is to provide a method and an architecture for managing data and an interface with which users can concretely and effectively apply against third parties—through the intermediary of the manager of the community, and therefore without needing a specific technological culture on their part and also without effort or engagement that go beyond the mere manifestation of will—some important rights guaranteed by the recent European law 679/2016 called GDPR, which came into force on 25 May 2018 in 28 countries. Rights such as, in particular, the right to data portability, revision and blocking of the self-profiling consent for sending commercial communication given to third parties, revision and blocking of consent to the transfer and merging of one's data with third and other parties. The possibility of investing and protecting for oneself one's own data, together with the action of the revisions and blocking indicated, completes and concretely obtains a simultaneous framework of data valorization for the user and of unequalled protection, today.

In particular, the automatic activation by proxy of data portability largely exceeds and expands any system based on software tracking and/or cookies regarding the recording of digital activities, expanding the collection and the grouping of data to all data that, referring to individual activities, have a digital transposition even if not originally produced by or during web browsing. The creation of a personal data bank, organized with a personal vault and several individual repositories, makes the digital life of everyone available, grouping it for the first time in the hands of people as an alternative to the power of large technology companies or companies that have extensive databases referring to all of us, for the broadest technological purposes and applications, both current and future, genuinely on the side of the people. Moreover, it makes a personal economic valorization possible which is not only based on the simple “sale” of the original data: it makes it possible to analyze them and create added value through the completeness and integration of all the data referring to the person, but also through the valorization of the person himself as a recipient—in a way that totally protects privacy—of personalized offers and therefore of a wider economic interest for the person himself and for the market.

The creation of the present invention also has another important field of application: since the present invention constitutes the filing of the broad-spectrum digital datum of the person, knowingly constructed by people (that is, not created, for the most part, without a declaration of purpose to individuals by the large technological companies as currently happens), a Proprietary Artificial Intelligence can be applied on it, more effectively than now happens on well-known deposits of large amounts of data, managed by the current largest technology companies, which are not completely interconnected and referable with certainty to a single subject.

Said A.I. will be able to guide, directly assuming the point of view of the advantages of the person, the interlocution with the commercial offers that are now increasingly and will in the future be conveyed in digital form, concluding smart contracts through a blockchain that is also proprietary, native and whose application is made ideal and natural, given the characteristics of the invention. It too, therefore, is on the side of the person.

The invention also lends itself to being a direct marketing platform with a short distribution chain, in which people-consumers have a direct participation and remuneration, ideal for the application of an expert service of intermediation and development of opportunities for valorization between people and the market that creates and increases the value of the data and that implements the method to redistribute said value to people.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purposes and according to a first characteristic aspect of the invention, the architecture for tracking and managing digital data, in particular digital data deriving from browsing the World Wide Web and/or also supplied or exchanged off-line with bodies such as service providers or other, by one or more users through interactions that tend to be mediated by connection instruments such as cards or suchlike, and/or one or more browsing devices, such as smartphones, tablets, personal computers or suchlike, equipped with a corresponding browser, comprises:
at least one app or interface configured to be loaded on the browsing device and in which the tracking and management of the digital data transmitted by one or more of said browsing devices is performed, the tracking is carried out by a Webtracker app or by a proprietary Identification Number;
at least one management platform provided with a centralized server able to receive the digital data transmitted by said one or more browsing devices or the digital data transmitted by third party bodies such as service providers or other;
at least one memory system to memorize the digital data, able to communicate with the centralized server of the management platform and with the one or more browsing devices and to allow to collect, organize, protect and make anonymous the digital data, and also to file and reconstruct the chronology or digital life of one or more users, each user being enabled to access the architecture and hence his/her own digital life thanks to the access of the browsing device in his/her possession to the centralized server by means of the interface;
at least a data masking app operatively communicating with said management platform and the interface.

The memory system of the digital data can be associated with a backend app.

The memory system can comprise a first protected database for filing sensitive data, and a second database for filing data able to be distributed and shared by the centralized server, which are therefore valorized data.

The architecture and in particular the data masking app can comprise an algorithm for encrypting the digital data transmitted by each user, so that each user is guaranteed confidentiality of the digital data transmitted, that is, a data protection tool.

The architecture can comprise an Advertising Individual Cancellation tool with an anti-noising&spamming function, that is, an individual advertising blocker request targeted to specific origins and/or communications, also on a wide scale.

The architecture can comprise an Advertising Lock&Locker tool, based in particular on the proposal and consequent completely voluntary acceptance of communications, offers and automatic feedback.

The architecture can comprise an Advertising&Product Feedback tool, that is, a form of advertising of products and offers for specific segments of the community; for this purpose there can be a sharing of digital data, always in a strictly protected form and mediated by the management of the community, with companies producing goods, for consulting and information purposes, and consequent personalized and targeted proposals. The aim is to obtain from this a source of valorization of the data and consequent return of the contact value individually to the members of the community who belong to the specific segments, without any obligation on their part to look at the communication, analyze the offer or even buy anything.

The architecture can comprise a sharing tool configured to allow communication between several devices and hence several users of the architecture, in social connection logistics.

The architecture can comprise an automatic Data Value Revendication tool against third parties (portability) to enact—in 28 European countries—the rights of data portability, or in any case to request a form of portability in non-European countries.

The architecture can comprise an interface to manage and display digital data that can be installed on browser devices, mobile or fixed, used by users to access the World Wide Web.

The invention also concerns a method for tracking and managing digital data, in particular digital data deriving from browsing the World Wide Web and/or supplied or exchanged with bodies such as service providers or other by one or more users through one or more browsing devices, such as smartphones, tablets, personal computers or suchlike, equipped with a corresponding browser. According to the present method the tracking occurs in particular by using the Identification Number, (cookies or suchlike), of the users of the architecture so as to add information but above all so as to configure a certain identifier to protect the individual because it identifies him/her, even toward third parties, as belonging to the specific community and therefore the bearer of requests and requiring certain types of protection and respect according to what the person expressed in the registration and during the use of the platform itself, as described above.

The method also comprises at least a step of receiving, in parallel and by a centralized server, the digital data transmitted by said one or more browsing devices during access to the World Wide Web; and at least a step of memorizing the digital data received by the centralized server and of filing and reconstructing the chronology or digital life of one or more users, each user being able to access his/her own digital life thanks to the access to said server of the browsing device in his/her possession.

These and other aspects, characteristics and advantages of the present disclosure will be better understood with reference to the following description, drawings and attached claims. The drawings, which are integrated and form part of the present description, show some forms of embodiment of the present invention, and together with the description, are intended to describe the principles of the disclosure.

The various aspects and characteristics described in the present description can be applied individually where possible. These individual aspects, for example aspects and characteristics described in the attached dependent claims, can be the object of divisional applications.

It is understood that any aspect or characteristic that is discovered, during the patenting process, to be already known, shall not be claimed and shall be the object of a disclaimer.

### BRIEF DESCRIPTION OF THE DRAWINGS

These and other characteristics of the present invention will become apparent from the following description of some embodiments, given as a non-restrictive example with reference to the attached drawings wherein:

FIG. 1 is a diagram of one embodiment of an architecture to track and manage digital data;

FIG. 2 is an overall diagram of a data center of the present architecture;

FIG. 3 is an overall diagram that shows the valorization and protection of the digital data with respect to the market;

FIGS. 4 to 17 are screens that show the present architecture on the user side, that is, as an app installed on a browsing device, for example a smartphone or other.

To facilitate comprehension, the same reference numbers have been used, where possible, to identify identical common elements in the drawings. It is understood that elements and characteristics of one embodiment can conveniently be incorporated into other embodiments without further clarifications.

### Detailed Description of Some Embodiments

We will now refer in detail to the various embodiments of the invention. Each example is supplied by way of illustration of the invention and shall not be understood as a limitation thereof. For example, the characteristics shown or described insomuch as they are part of one embodiment can be adopted on, or in association with, other embodiments to produce another embodiment. It is understood that the present invention shall comprise all such modifications and variants.

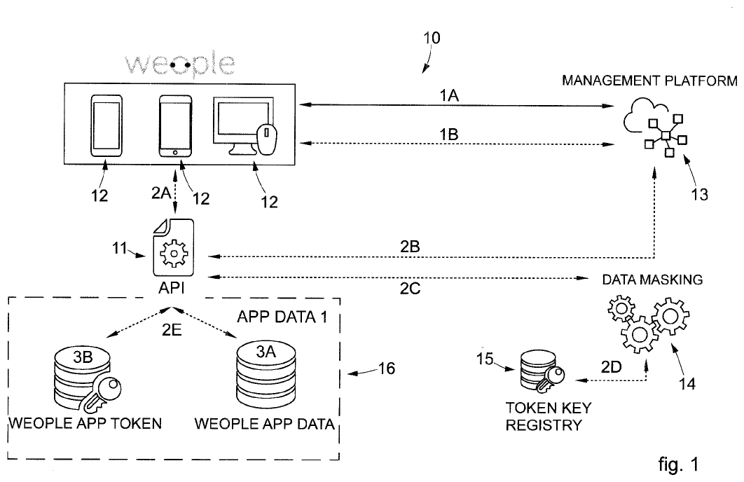

With reference to the attached drawings and for example to FIG. 1, an architecture 10 for tracking and managing digital data according to the invention comprises at least one interface 11, in particular a software app, suitable to be loaded on a given mobile or fixed browser device 12, used by the user to connect to the web.

The interface 11 is configured to manage and display data, and also to provide the user with all the features and benefits of the invention.

The architecture 10 also comprises a management platform 13 to collect the user's indications relating to the data that he/she wants to merge into the architecture 10 for tracking and managing digital data. A centralized server can be provided in the management platform 13.

The management platform 13, together with the overall architecture 10, is configured as innovative and alternative to the use of tracker software of digital behavior to be inserted in mobile or fixed devices 12.

In the present application the web trackers can be provided even if the operating systems (especially those for mobile devices) automatically discourage or inhibit them through battery-wear saving systems, or prevent exports to external repositories of data collected on the mobile device. The alternative would be to use VPN and Proxy server systems but the user experience is often greatly damaged and the use is no longer serene and useful.

The architecture 10 also comprises a data tracking system which can comprise a Webtracker app or tracking using an Identification Number (cookies or suchlike) of the users of the architecture in such a way as to add information, but above all such as to configure a certain identification to protect the individual because it identifies him/her, also against third parties, as belonging to the specific community and therefore the bearer of requests and requiring certain types of protection and respect according to what the person expressed in the registration and during the use of the platform itself. The architecture 10 also comprises a data masking app 14 suitable to exchange data with an authentication register 15. The data masking app 14 communicates operatively with the management platform 13 and the interface 11.

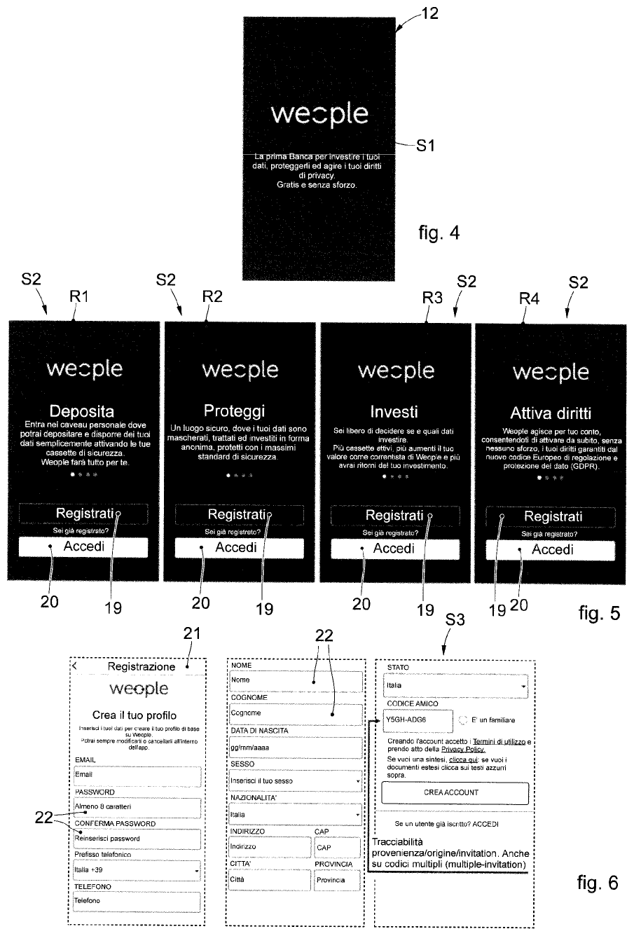

On a user level, the architecture 10 is configured as an app to be installed on its own browser device 12, as will be shown by way of example with reference to the screens of FIGS. 4 to 18.

The interface 11 can communicate with a data memorization system 16 (APP DATA 1), in particular cooperating with a backend app, where all the data coming from the browser device 12 in the possession of the user are saved, therefore, for example, registration forms, activation of digital account safety boxes, loyalty cards, etc.—and request for the portability of digital data to the present architecture 10, in particular the management platform 13.

The memorization system 16 comprises a first protected database 3B for filing sensitive data and a second database 3A for data able to be distributed and shared by the centralized server, that is, by the management platform 13, hence valorized data.

Only the user who provided such data, as well as the Data Holder/Controller will be able to access, through appropriate credentials, the protected database 3B of sensitive data, for reasons relating to the security or provision of specific services and benefits.

Line 1A represents a data communication line between the management platform 13 and the browser device 12, while the lines 2A, 2B, 2C, 2D and 2E represent flows of activity between the various elements of the architecture 10.

Line 1A concerns management activities in relation with the user by the management platform 13, automatic and manual contact of users via notification, management of communications, bulletin board, loyalty programs, customer care and others.

In particular, the data flowing from the browser device 12 to the management platform 13 can concern the user's registration data on the management platform 13.

The data flowing from the management platform 13 to the browser device 12 concern the provision of contents and communications, for example push notification and various communications.

Line 2A refers in one direction to the data concerning the request to activate the portability of digital data for each account to the app, data about the status of each account, generic activities in the app, for example functions such as like/dislike, possibility of prizes—participation in promotions, mainly linked to the user's personal account and to the app's entertainment area). Through his/her portability right, the user can have his/her data available.

Line 2A in the other direction concerns the data that the user can view in the app and relating to the personal accounts activated and to the state defined for each of them. In this way, advantageously, the disaggregation of digital data for users is overcome.

Line 2B concerns the data relating to activations of the accounts (app activities) toward the management platform 13 and data relating to the user's request to exercise his/her rights for each account.

Lines 2B and 2C also concern data that can be entered on the registration forms to the data masking app or service 14 and/or to the app installed on the browser device 12.

Line 2C also concerns the return of the unencrypted data for user contact, for example in the event of a prize in the app's win area. This contact can be made by a signal, a message or other.

The line 2D concerns the creation and storage of the token and reverse process keys. In the reverse case, the data is returned to the user unencrypted.

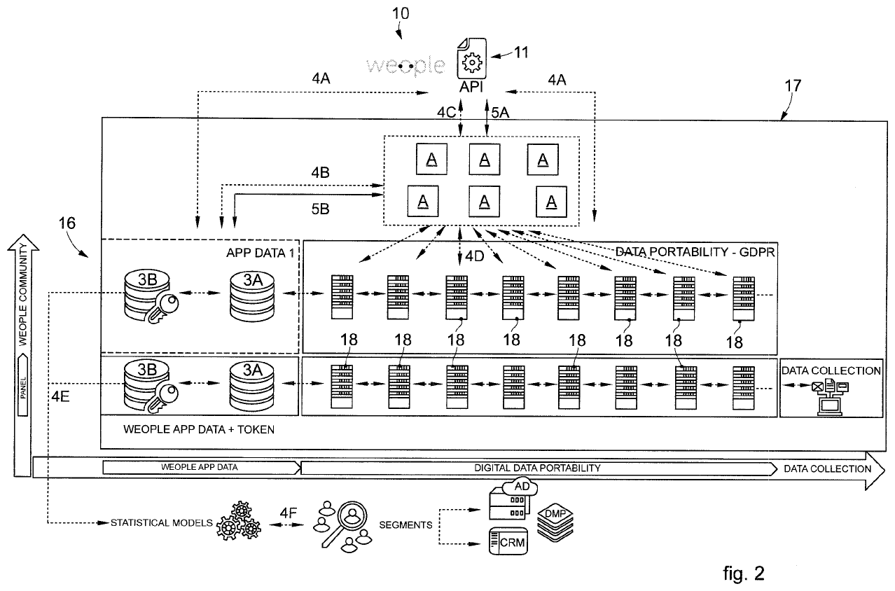

FIG. 2 shows a data center 17 in its entirety. The data line 4A essentially refers to the data from and to the management platform 13 and to the data of all the activity requests made by the user inside any section of the app installed on the browser device.

FIG. 2 also schematically shows one or more companies A, or service providers or more generally bodies with which the user shares personal data.

Lines 4B and 4C concern data sent to companies A for access to personal accounts; the app conveys requests for data portability to companies and receives affirmative or negative response data (link distinctive element—user). By means of the app, the present architecture directly executes the request for access and portability to the company by connecting via API to the access gate of the company itself and communicating its access data (username and password remain in the exclusive possession of the user).

Line 4D concerns the digital data of the user flowing from the companies A to the data center 17, additional request data or confirmation of receipt by the platform to the companies. Digital data not declared but electronically registered by the companies are available for the user.

Line 4E concerns normalized data, processed by the management platform 13 for valorization activities, for example using statistical algorithms on aggregated data. The wealth of information and knowledge of the most advanced segmentation techniques lead to a potential enrichment of the data that is very interesting for companies.

Line 4F concerns the creation of interesting population segments for companies A. For example, data flow from statistical engine or to statistical engine for modification and new processing.

Lines 4A-4F described above therefore concern data flows between the various elements of the data center 17 and of the architecture 10.

The activity flow lines 5A and 5B exemplify the fact that after activation of the account by the user, the present app or architecture conveys the requests for data portability to the companies A.

This system overcomes the traditional tracking systems of web browsing through software or the detection of consumption and purchases by declaration. All this is made possible by the law ratified for example by the European law 679/2016 GDPR that allows the user to request, as a citizen, the copy of their digital data from those who own them, having them filed with third parties—this architecture and in particular the management platform 13—in an electronic format that can be acquired and easily read and interpreted. This request will be made directly and automatically (without any effort or engagement) by the user via the access interface 11 on the websites of the companies A.

The first step is managed by registering the request for digital data portability by the user in the backend app 16. The request is conveyed by the architecture 10 through the management platform 13 to the companies that hold the data, and can also be not in real time if there are no access interfaces to these ready-to-use companies in order to download their data, line 5B.

In the backend app 16 all the data coming from the app in the possession of the user on the browser device 12 are saved, therefore, for example, registration forms, activation of safety boxes—digital accounts and request to carry the digital data to the present architecture 10, in particular the management platform 13.

The DATA PORTABILITY-GDPR block concerns the digital data coming directly from the companies, following the request for portability carried by the management platform 13 on behalf of the user. In this block a series of computers 18 with databases are symbolized, which can each be associated with data of a specific type or service: for example a database relating to data arriving from social networks, a database relating to data arriving from loyalty cards, a database dedicated to banks and insurance companies, a database dedicated to web providers and others.

The PANEL block concerns a network of collaborators, subscribed to the architecture 10 but who are recruited separately and who collaborate with the present app or architecture with a panel collaboration contract. Their task is much wider than the noRmal account holder who uses the architecture. The panel is stratified in a representative way; the panelists invest their digital data by activating all the safety boxes in agreement (while for the normal current account holder the choice is completely optional) in the present app; they reply to questionnaires administered via an external data collection system. Moreover, they are equipped with a personal technological device called “meter”, to detect the passive off-line television/radio exposure. It will be clear that this element, which is not essential or necessary, is nevertheless an important, other characteristic for collecting further sure data and integrating it with those already in the possession of the architecture to the full advantage of completeness, harmonization and representativeness of the final set of data. This translates directly into a greater potential valorization of the offer described here to the advantage of both account holders and the market.

The DATA COLLECTION block concerns profile data from external sources, for example detection software of web questionnaires, data received from technological devices called “meters”, that is, for the passive registration of off-line multimedia exposure, for example TV, radio or suchlike, in particular, as we said, in the possession of the panelists. In this block a series of computers 18 are symbolized, with databases that can each be associated with data of a specific type or service: for example a database relating to data arriving from social networks, a database relating to data arriving from loyalty cards, a database dedicated to banks and insurance companies, a database dedicated to web providers and others. The computers are integrated, where necessary, with the others already indicated with the numerical reference 18.

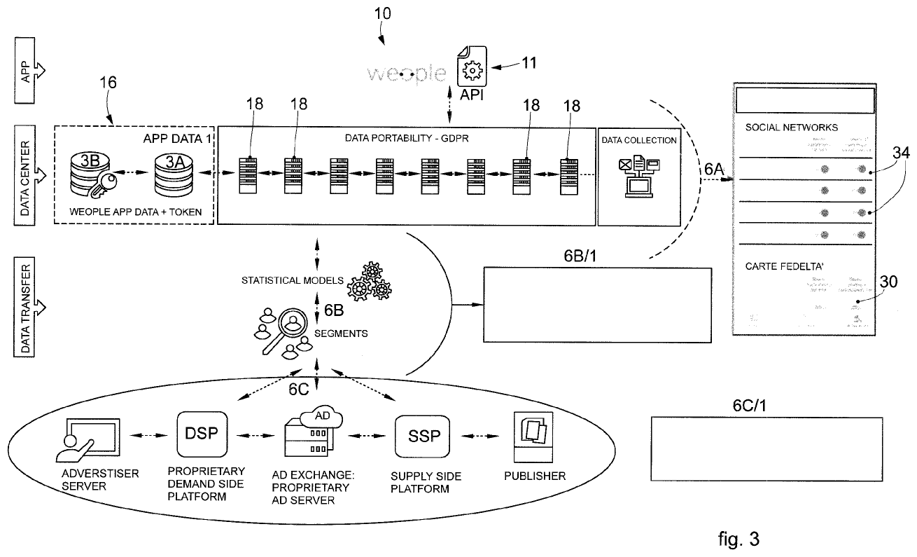

FIG. 3 shows an overall diagram of the activities and elements of valorization and protection of the user's digital data in the market.

Data line 6A concerns the activation of data portability requests to the management platform 13 of the present architecture 10 and the simultaneous blocking of marketing by third parties and/or the transfer of data to third parties. This generates the maximum protection and valorization of the user profile and configures a precise and innovative function of Advertising Individual Cancellation with anti-noising/spamming function.

Data line 6B concerns the creation of a data dictionary and segments through advanced data processing and statistical models. These are a tool to provide value to individuals and the community by attracting investors. The investment and the creation of value for account holders or users of the architecture can be done using the app on their own browser device 12 as a means of contact as indicated in block 6B/1 (as already described, contacts are mediated by the management platform 13 and prevent disclosure of the contacts and of the user profiles).

Block 6B/1 in particular concerns: proposing segments to companies; total management of contacts and individual delivery without disclosure of the profiles and contacts themselves; downloading individual value into a moneybox, which will be indicated with reference to the description of the screens in FIGS. 4-18.

However, the creation of the segments also supports valorization as indicated in elements 6C-6C/1.

Data line 6C concerns the valorization of the segments of the market in data integration and/or programmatic; it takes place in a protected way thanks to the presence of a proprietary supply chain and in particular thanks to the presence of a DSP that keeps the profiles anonymous without transferring them to third parties. The value generated is returned to the account holders as described in 6C/1.

Block 6C/1 concerns the calculation or value cycle coming from data integration/programmatic. According to this block the collective value is downloaded, for example by means of the winnings mechanism, see the screens in FIGS. 4 to 18.

The person of skill will understand that the present architecture 10, together with the presence of a chain of instruments at his/her disposal and indicated in 6C, in particular the ADVERTISER SERVER, the DSP and the SSP, obtain for the first time a series of benefits and of characterizations, solving problems not yet resolved: the collection and management of data relating to the digital life of the individual in a repository at his/her disposal, with numerous control, management and valorization functions, in an ecosystem that, today, sees how the data of all of us get lost in thousands of streams and repositories, with no possibility of control and intervention. They also allow, through the on-time and continuous management of the proprietary IDs, a real control, reduction and redirection of communication noising and “pollution” from overexposure—nowadays totally uncontrolled—by the individual, in the quantity and in the modes defined by him/her: benefits that can be easily obtained by combining the supply chain 6C with the simple and natural interaction with the app on the browser device 12, in particular with the “personalized offers” section—which allows to classify and index the interactions of the account holder with the section itself, with the consequent display and like/dislike—integrated with the “enact further rights” section.

The present architecture 10 also obtains, for the first time, the economic valorization of the data of the individual in favor of the individual, giving him/her concretely and operationally a protagonist role that until now has been completely absent, although indicated by several laws regarding data and privacy (for example, European law 679/2016 GDPR).

On the user/client side of the data (that is, for example, Advertisers, Companies, Media Centers or other), the architecture 10 obtains for the first time a concrete optimization mechanism (waste reduction, greater precision and correct and direct dialogue with the real market potential) and systemic sharing of economic value, in an unprecedented win-win-win flow with innovative and substantial advantages in image and economic return.

Below and with reference to FIGS. 4 to 18, the characteristics of the interface 11 are presented, with screen shots of the app associated with the interface 11.

FIG. 4 shows schematically a browser device 12, for example a smartphone on which the app associated with the present architecture 10 is uploaded and which has, upon opening, a welcome screen S1.

From this welcome screen S1, for example by touching or scrolling on the screen of the smartphone, additional screens S2 can be accessed, for example a plurality of screens S2 provided with sliders R1, R2, R3 and R4.

In each of the sliders R1, R2, R3 and R4 a record button 19 and an access button 20 can be provided.

The sliders R1, R2, R3 and R4 synthetically present the main functions of the interface 11 associated with the architecture 10: filing one's data by opening one's own, innovative, data current account=slider R1; protecting them=slider R2; investing them=slider R3; through the active intermediation of the architecture that will redistribute the bulk of the benefits obtained to individual users, or activate their rights of privacy and data possession=slider R4.

FIG. 6 shows a screen S3 of the app in which there is an enrolment and registration form 21 for the present app, which shows some fields 22 that can be filled in with their own data, general information and other.

The enrolment form 21 is a first data investment and also activates the data current account, which takes the form of a personal vault.

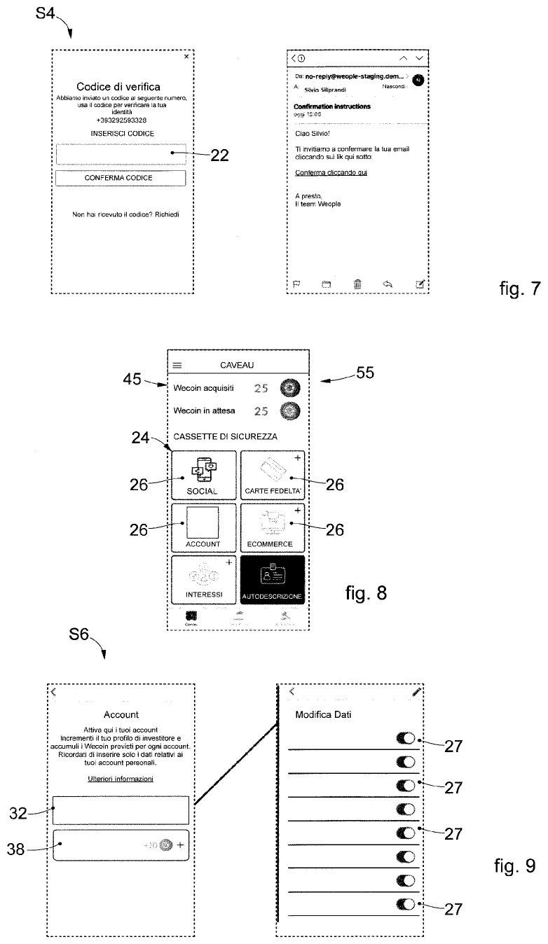

The screen S4 in FIG. 7 shows the process of automatic validation of telephone number and e-mail.

For example, a verification code sent by the app can be entered in a fillable field 23.

FIG. 8 shows a screen S5 in which a personal vault 25 is shown with some safety boxes 26 that refer to an equal number of web accounts or repositories of digital data generated off-line but recallable and aggregatable, on a univocal individual, inside the architecture.

The diagram also has a virtual currency, block 45, generated by the interface or app that serves to give a measurement to the individual as a data investor. We are speaking about a greater or lesser quantity and quality of data=greater or lesser investor-level value. The virtual coins have double valence: a) they consequently “instruct”, that is, in proportion to the accumulated value they represent, the mechanisms that vary the individual economic returns (which we will discuss later); b) is a necessary basis for the application of a blockchain-type procedure.

Hereafter we will examine the individual safety boxes, in terMs of characteristics and contents, pointing out now that what we will describe is in no way to be considered as exhaustive representation: the safety boxes 26 shown here and already developed in the interface 10 will be joined by numerous others, the development of which has potentially no limits.

In particular, other safety boxes 26, for example six boxes, in addition to those mentioned here, have already been developed and listed here as a non-restrictive example: 1) Utilities—water, electricity and gas; 2) Finance (current accounts and payment tools); 3) Telephony; 4) Health; 5) Entertainment/contents on demand; 6) Internet of Things.

FIG. 9 shows an example screen S6 of the functioning steps of the architecture and in particular the investment of the account associated with a determinate online service provider 32, for example browsers, storage spaces, multimedia products, games, activities and other, or service provider. It is also possible to provide a command 38 to add a particular service provider.

The app connects automatically and effortlessly from the user to the page of the service provider (not easy to identify for the individual, even if he/she is willing) where there are the repositories 27 of data collected constantly by the service provider in relation to all the individuals who use its services, including web browsing and the use of the apparatuses.

This app displays and lists them; the user can modify them at will, thus inhibiting the investment in the app and also the data collection by the service provider. Or he/she can invest them for him/herself in the app. The app will ensure that, through a specific request and/or an automatic connection, in direct representation of the account holder of the app, the data also arrive in the account of the account holder and generate value for him. A similar procedure will be applied to any investment in another service provider.

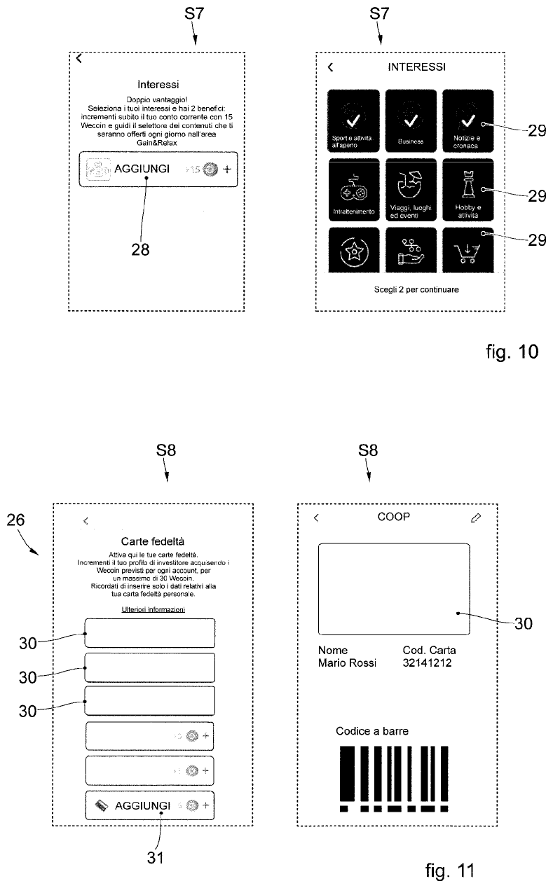

FIG. 10 shows two screens S7 relating to interests. The user of the app, if desired, and through a special command 28, can indicate a series of personal interests in the safety box, simply by touching the specific icons 29.

These choices not only represent themselves and are therefore an investment of data for all purposes, they also inform the web content grabber offered as a service in the next section called “Gain&Relax”, which will be described below shortly.

Furthermore, together with the classification and indexing of interactions with the Personalized Offers, they contribute to directing the offers themselves, effectively contributing to making the communication itself more personalized and pleasant, reducing noising and communicative pollution. The section “Activate further Rights”, which we will see shortly, also contributes, as already mentioned, to these two results/benefits and in a very direct way.

FIG. 11 show two screens S8 relating to a safety box 26 containing a list of loyalty cards 30 and to the enlarged display of one of the loyalty cards 30′.

In this safety box 26 the account holder can invest all the loyalty cards 30 he/she has. The safety box 26 has a predefined list but also a command 31 to integrate the list as desired. This is a case of digital data not necessarily generated at the same time the web is used (unless the loyalty card is used only for online purchases) but “off-line”, that is, at the point of sale and then immediately transferred and memorized in a digital database at the retailer's.

Inside the safety box 26 all the user's data are contained, which he/she him/herself can concretely obtain on request, in accordance with data portability (moreover ratified by law 679/2016 GDPR). These data, obtainable by the user and relating to his/her purchase behavior, are, for example: date and place of purchase, description of the single item, its code, weight, price on the shelf and possible discount, promotions, gifts from points, etc.

The data can be displayed in a precise and complete way, for example in the form of a spreadsheet. It will not escape the person of skill that, for the first time and thanks to this app and architecture, the data can be collected in one's own account or personal data file. The data relating to our digital or digitalized life are, all together, tracked back to the same person with certainty, while until today they have been unavailable to anyone.

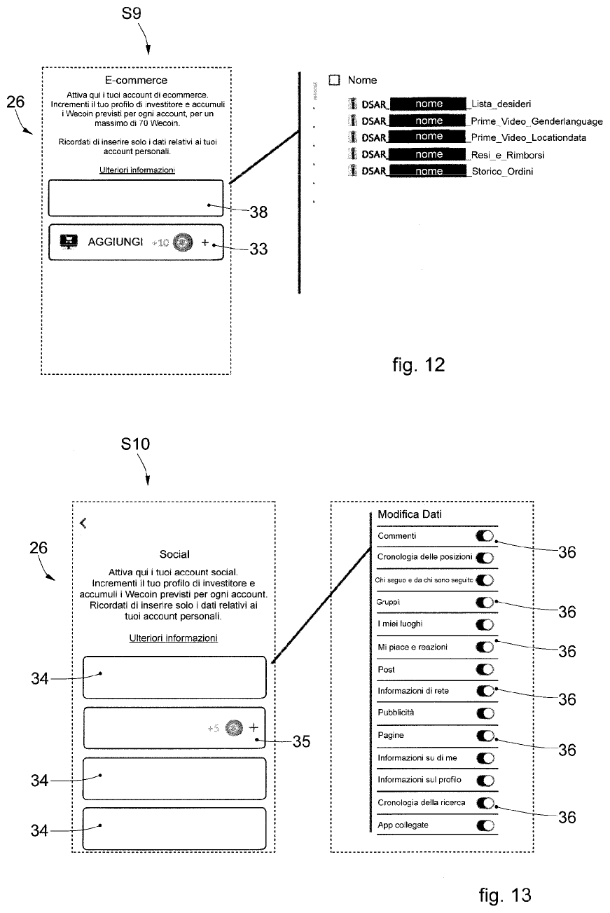

FIG. 12 shows a screen S9 relating to an e-commerce account 38. In this safety box 26 the account holder or user can invest the eCommerce accounts he uses. The box has a predefined list but also an additional command 33 to integrate the list as desired.

As previously seen for loyalty cards, the user can obtain, simply, quickly and completely, for example in the form of a spreadsheet, the data actually generated by him/her. The data can be provided on the request of an individual who has appealed to data portability (moreover ratified by law 679/2016 GDPR).

The data obtainable by the user and relating to his/her purchase behavior are, for example, the date of the order, number of the order, cost of the article, taxes, shipping costs, identification code of the product purchased and the description of the article. FIG. 13 shows a screen S10 of an example of an investment in a social network 34. A command 35 is provided to add other social accounts.

Considering any of the social accounts 34 whatsoever, the app connects automatically and effortlessly from the user to the main page of the social account (not easy to identify for the individual even if he/she is willing) where there are repositories 36 of data collected constantly from the social platform in relation to all the individuals who use its services. The present app displays and lists them; the user can modify them at will thus inhibiting the investment in this app and also the data collection by the social platform. Or he/she can invest them for him/herself with the present architecture and app. The app will ensure that, through a precise request and/or an automatic connection, in direct representation of the account holder of the present app, the data also arrive in the account of the account holder and generate value for him/her.

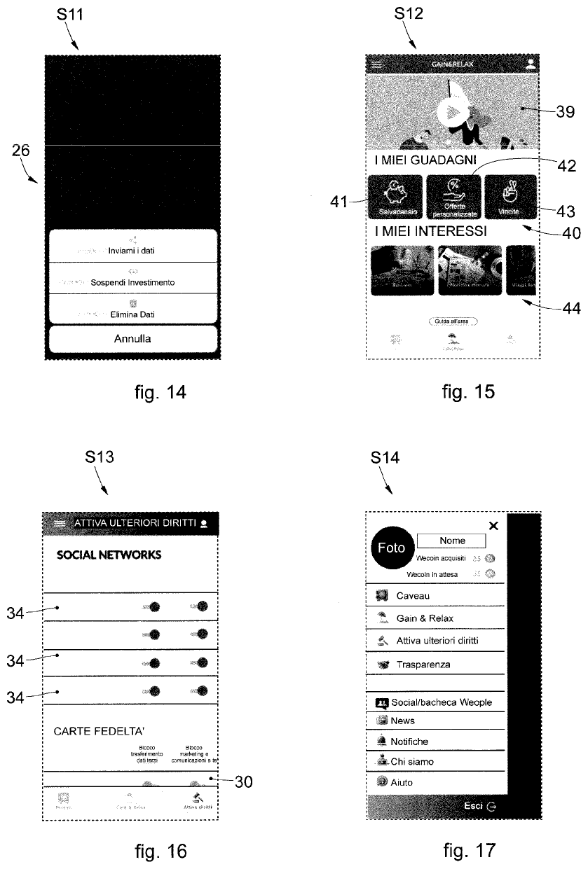

FIG. 14 shows a screen S11 relating to any safety box 26. For each safety box, the app allows autonomous management by the account holder or user; in particular, the user, if he/she so desires, will be able to see concretely that data have arrived and are available in his/her personal account, at the same time he/she can have a copy or request cancellation or suspend the investment.

FIG. 15 shows a screen S12 of a section of the app called “Gain&Relax”. This is the area in which the account holder or user benefits from the economic and play advantages of the architecture and its interface. In particular, the area contains: a visualizer 39 for communications and audio-video contents; a section 40 “my earnings” in which he/she benefits from three ways of valorizing the data, represented by blocks 41, 42, 43:

1) block 41: block 41 is a sort of moneybox and here the money (true, not virtual) that the app will obtain by carrying communications (on the visualizer mentioned above) and personalized offers to specific segments of account holders who will have shown, with a proactive commercial action of brokerage, to be interesting for some specific companies, will be collected and registered to the individual. The communication and possible personalized offer will be conveyed only by the app: the disclosure of personal data and profiles of individual account holders to the companies concerned is not allowed under any circumstances;

2) block 42, relating to personalized offers (a company has paid the individual to send these): here the account holder or user will be able to benefit from the personalized offer, deepening it as desired, without there being any obligation to deepen it, let alone to purchase it. The interaction (or non-interaction) between the account holder and the personalized offers, together with what happened in terms of interaction with the visualizer (viewability), will be adequately indexed and will accumulate a history and indicators that will allow to obtain here a communication and personalized offer container called, in the first version, ADV Lock&Locker. Here potentially interesting communications are collected and at the same time those that are potentially disturbing, excessive, etc. are blocked, also contributing to the anti-noising/pollution function—a function that is also greatly strengthened by the section called “activate further rights”-mentioned above;

3) block 43, relating to winnings: the money generated by non-individual activities on data, such as for example data integration, which will always be conducted anonymously and protectively for the profiles, and therefore inside the DMP-DSP-SSP-ADServer chain of the app without passing sensitive and identifying data to third parties, will be distributed here, in the foi in of draw winnings. It would be very difficult to establish the individual contribution of the data to these activities which are eminently based on “mass” data, and therefore a personal remuneration as in the case of the moneybox is not possible. The draws will be oriented by the algorithm that assigns virtual coins based on the quantity and value of the data invested by each account holder, therefore, specifically, different prizes of increasing value will be established for different and increasing levels of data investment by the individual.

Both for the moneybox and for the winnings, the remuneration model is particularly in favor of people: the app will redistribute—through the moneybox and the winnings function—90% of the profit generated by the activities of intermediation and data valorization with the market. Therefore, once the documented operating expenses and costs have been subtracted, 10% of the remainder will represent the remuneration of the app, while 90% will be redistributed to the account holders. A transparency page of the costs, expenses and revenues obtained, situated in the final menu of the app (see below) and a certification (periodical and published) by specialized companies and third parties, complete the picture.

An area 44 called “my interests” closes the section in which, according to the interests activated in the dedicated safety box, a web content grabber is activated to present to the account holder, each time he/she selects an icon, the relevant more current and interesting contents. An automatic algorithm will progressively improve, as the section is progressively used, the presentation of the contents according to the interests really activated and the in-depth contents. All this will also contribute to the Lock&Locker and anti-noising/spamming function, improving the addressing of communications and preventing unnecessary redundancy for the individual.

FIG. 16 shows a screen S13 relating to a section where a user can activate his/her rights. In this section the account holder or user can exercise the right to revise authorizations to companies and third parties in general who can have his/her digital or non-digital data; this right is provided and recoded not only by the European law 679/2016 GDPR but in all previous legislations, including non-European ones, in tei ins of privacy. In particular, with a simple click one can block the transfer of data to third parties—a profitable practice for data holders, put in place for the purposes of advertising or influence, now particularly widespread and harmful for the individual, as well as on the basis of many (and growing) scandals and alarms on an international level—and the profiling activity on the data that a company performs not in the name of its characteristic activity but to be able to send commercial communications to the individual. In this case, both profiling and sending are inhibited as an activity. It should be noted that it is theoretically possible for the individual to enact these rights individually in a direct interaction with the individual company, but the practices and paths are not at all simple, and instead are intended to discourage the refusal of authorizations and, on the contrary, to obtain both concessions on a stable basis. In fact, current practices discourage the majority.

The present app and architecture solves this problem, simply collecting the will of the individual at the head of every account or report activated in the safety box—which appear automatically in this section, available to the account holder—and convey these requests to the target companies automatically and in representation logic. This function of the app concretely obtains various protections in favor of the individual, not least the Locker and the protection from communicative and/or unwanted pollution, since the manifestation of will is addressed to one or more companies. Moreover, the person of skill will also understand that the combination of investment in a safety box and the blocking of authorizations as described here ensures that the data “work” in favor of the single account holder, in a path that can be not only profitable but also with great personalization, control and satisfaction, with a magnitude and characteristics that are completely new compared to what happens and can be done or obtained today.

FIG. 17 shows another screen S14 of the present app relating to a transparency section. In this area the account holder or user finds all the sections of the app grouped together, as well as news, notifications, FAQs, social (the interface allows to share experiences, earnings, etc. on the main social networks and also has an internal connection board).

The transparency area consists both of the terms&conditions and the income data, expenditure and fixed and current costs that the platform supports, as well as what has been redistributed in the various forms and with the means provided above. The publication can be quarterly or semi-annual and will be accompanied by the certification of specialized third-party companies.

The invention, in short, contains an automated system—connected and consequent to the expressed will as above—to request data from the third parties in possession thereof.

The system or architecture comprises at least one centralized server able to receive, in parallel, the digital data transmitted by said one or more browser devices during use of the interface app.

The system or architecture also comprises at least one digital data memorization device able to communicate with the centralized server and with the one or more browser devices, and to enable the collection, organization, protection and anonymization of the digital data, as well as the filing and reconstruction of the chronology or digital life of one or more users; each user is enabled to access the architecture and therefore his/her digital life thanks to the access of the browser device in his/her possession to the centralized server through the interface.

As we have seen, the data memorization device or backend app 16 associated with the centralized server comprises the first protected database 3B for filing sensitive data and a second database 3A of data to be distributed and shared by the centralized server, hence valorized data.

Only the user who provided such data, as well as the Data Holder/Controller will be able to access the database 3B of sensitive data, which is protected, through suitable credentials, for reasons relating to security or the provision of specific services and benefits.

Both types of data, sensitive or private and valorized, are suitably protected by a suitable algorithm or cryptographic process.

The present architecture, able to generate a community, operates as a sort of “data investment bank for the individual person”. The data is not only protected but invested—by the manager of the community, anonymously with respect to the individual members—in the market, producing an economic return for the members of the community.

The architecture can be used by users by means of a software app that can be uploaded to mobile devices (for example smartphones, tablets or suchlike) and Personal Computers. The app is present in the main sites or virtual stores (so-called “Stores”) on the Web, hence current virtual stores. It can also be configured for future ones.

Upload is free, as is as the release of the broad spectrum benefits to the community and its individual members.

The upload provides the possibility of acting as a “data account holder” by subscribing to the app by filling in a basic card relating to the characteristics of the individual member and acceptance of the rules, conventions and guarantees of the community.

With the upload, the individual subscribing becomes part of the community and this already configures a first level of the right to participate in the value that will be shared by the community, as it entails not only filling in the form as above, but also investing his/her basic digital data: the app is authorized to track the use of the web by the individual within the ever narrower limits and in some cases (iOS) no longer existing, allowed today by mobile and fixed operating systems and also by AD Blockers that delete cookies and similar identifiers. To overcome this limitation—binding and progressive that afflicts all software trackers of any kind (unless—as in the case of online service providers—one does not have a proprietary operating system) the app has developed its own innovative method based on the voluntary investment, by the user, of his/her web accounts or tools for connecting to digital data, for example, loyalty cards. The user, by joining the app and activating the safety boxes in his/her vault, indicates his/her willingness to make his/her data—currently owned by third parties—arrive in his/her current account data in the present app. The present app or architecture is activated, by proxy and representation, to request this transfer, which can occur periodically or constantly, through an API, or appropriate interface.

The architecture proposes successive levels of data investment with corresponding repositories (“safety boxes”) protected, guaranteed and technically put in synergy with the other data already “paid” and invested in the community itself. These subsequent levels are not obligatory and, if chosen by the person, will be obligatory on an informed and guaranteed basis. These successive levels are expressed in the attached diagrams although what is indicated is not binding and not susceptible of further expansion.

The processing and use of the data by the architecture, in terms of investment in the market, is done in a strictly anonymous form.

The investment channels will be as follows, indicated here as non-exhaustive: programmatic, including the private and privileged market of digital contacts on a qualified database; data enrichment; media and advertising; trading of goods and services.

The architecture will be able to invest the data on the market, according to the above, and will share with the members of the community the value generated, according to the already indicated logic of sharing (better defined below on the basis of market success): once the fixed and current operating expenses and costs have been deducted, 90% of the remaining profit will be returned to the user through two main systems: moneybox (direct individual remuneration) and winnings (remuneration from collective data); the possibility of also having many personalized and individual offers completes the framework of advantages.

The architecture can be equipped with a calculation algorithm that will vary the probability of being drawn based on the quantity and quality of data shared, for example according to the following principle: if the member only invests his/her basic digital data, he/she will receive in association a basic probability, conventionally=1, of being drawn; if he/she invests increasing quotas of his/her data, as described above in reference to the subsequent non-obligatory levels, he/she will receive in association an increasing probability of being drawn.

The increasing probability is automatically proportioned by the algorithm to the quantity and the quality/market value of the data invested.

The present architecture represents the ideal base, conceived and managed by the individual for the first time, for applying a blockchain for the conclusion of smart contracts, as well as for applying an Artificial Intelligence (AI) that is on the side of the people and that is therefore delegated to interact with the various intelligences available today and in the future, evaluating the proposals and advising the person in the process of concluding contracts (smart or not). The big difference is that the architecture presented here obtains for the first time what is necessary so that people, citizens-consumers, have at their disposal their complete data and therefore what is needed to make self-generated evaluations (also assisted by AI), in a world that is increasingly a big data world, where those who have the big data usually dominate or will have the possibility to try manipulations through AI and the communicative proposition. Communication filters, collection of a large amount of data by the same person, return of economic value to the person, A.I. on the side of the person, a large community of people, a proprietary blockchain: these are the elements that reduce the risks of manipulation, making people autonomous and protagonists in a totally unusual way, which, in the final instance, is the strategic purpose of the present app.

The present architecture, able to generate the community described above, is therefore essentially based on trust and transparency from all points of view (activities, agreements, terms and conditions, budget, etc.), and the sharing of digital data. The reflection of this is very clear in the transparency page already described and in the terms&conditions.

The present architecture is therefore equipped with the following software functions or tools, which are listed below and are intended to be present individually, or variously combined with each other.

The tools can be:
a “data protection” tool, extended to the accounts “paid” as an investment in the community, that is, a Data Bank function; this tool takes the form, as we said, of a procedure for encrypting the data received from the architecture and a system of dedicated and protected repositories;
an “advertising blocker” tool, on a voluntary basis and on the explicit request of the individual, to participate in the Community, and an “advertising individual cancellation” tool with anti-noising&spamming function: individual request for advertising blockers intended for specific communications and/or specific origins, even on a large scale, with or without feed-back: for all this we have seen the “enact further rights” section, together with indexing in the Gain&Relax section and also the possibility of the ADSERVER/DSP supply chain to limit contacts to a certain ID owner assigned by the app;
an “advertising lock&locker” tool, based on the voluntary acceptance of communications and feed-back: see the “personalized offers” function and the visualizer for audio-video displays in the “Gain&Relax” section;
an “advertising&product feed back” tool, a form of social “dialogue” with companies on communication and products, for consulting and information purposes: interaction and fruition data suitably classified and indexed and supplied by the present app to advertisers (function connected to the previous one);
a “social sharing and evaluation” tool of experiences relating to winnings, etc., as well as a “social sharing” tool on the web experience, infringed rights, protection needs, etc.: see sharing experiences directly on the most important social networks and the bulletin board of the app;
a “data value revendication” tool against third parties, that is, the re-appropriation of their digital data and at least part of their value and/or providing users with the unprecedented possibility of being able to invest them individually for their own profit: see the “bank vault” section and safety boxes and automatic process of request for data portability, mediated by the present app and without efforts, except for the activation of the safety boxes, by the user.

The above cryptographic tool or process can comprise the separation of sensitive data (Identity) from digital journey data, purchase, etc., hence the generation of an encrypted connection key.

In this regard, as we said above, it can be provided that the centralized server is associated with a data memorization device comprising a first protected database for filing sensitive data and a second database of data able to be distributed and shared by the centralized server.

Only the user who provided such sensitive data, as well as the Data Holder/Controller can have access to the protected database of sensitive data, as mentioned above and through appropriate credentials, solely for the purposes relating to the characteristic activity of the architecture and in favor of the account holder-user.

The present architecture, therefore, in addition to the functions and processes described, as well as allowing to reconstruct and modify the digital life of users based on the digital data provided by each of them, and allowing to increase the security and efficiency of the data transmitted, intends to provide answers to some important needs, emerging and relating to the use of the web. These needs rest on some mega-trends, already present and in strong, further growth:
the sharing economy, that is, the concept of economic sharing of goods, services and tools—in our case, data—to generate added value for all, including individual users, bringing them usefulness, with minimum effort, and increased availability of services and goods, and with the possibility of choice;
the protection of privacy, that is, the value of privacy and the need to protect it, even more in the digital environment. The repeated and growing alarms on this level and the increasing activity of legislation and restriction in this field, bring with them, for people, an increase in the awareness of how sensitive the issue of privacy is, and the awareness, on the part of the individual, of a new need for protection and respect for what is “private” (in our case, the data and how much they can say about us).

It should be considered that the era of big data has already more than begun, according to which very soon, with blockchains and the possibility of closing smart contracts, we will receive, in the billion digital streams (which will be the fabric for exploiting everything and distributing all audio-video contents), offers presented as personalized and indispensable by Artificial Intelligences that have our data but do not belong to us: in fact: data, AI, blockchains and smartcontracting systems now belong only to technology companies and to the thousand companies in which we transfer behaviors translated into digital data and that often, after payment and co-business, are merged with the data of the technology companies. In all this, nobody is actually dealing with people, the citizens-consumers. The present app wants to fill this gap powerfully, organizing the most complete database of people for people, to make them participate as protagonists—and defended by their own means, equal to and better than the others (thanks to the completeness of the data)—in all of the above. On these issues very soon people, perhaps without full awareness, will risk their dignity and freedom, it is therefore necessary to provide them with autonomy and concrete protection.

The present app also intends to valorize the individual, as an economic subject, with rights and fair expectations of recognition. This is the longest-lasting trend, which leads to an increased awareness of individual value, as citizens and as consumers, in an independent, indifferent and indeed diametrically opposite way, to being part of “masses of equals”. One consequence is the growing disintermediation—as a practice and as an ethical/behavioral value—which is increasing among people at all levels. In our case, it leads to a growing awareness of the value of individual data and of the individual act of production of data, even if the data, brought back to the individual, are objectively less forceful. A one-to-one mass marketing is developing in practice and in techniques, which feeds on data, no less, and gives them a growing market value. Also the individual must be able to benefit from this value, according to his/her share, since he/she is the producer-holder of the data in all respects.

The present architecture, therefore, which is able to generate a community, gives a precise answer to all these sensibilities, questions and needs—whether they are already known and felt or embryonic—through specific services and characteristics. Services and characteristics that, together with the answers, nobody supplies today regarding digital (and non-digital) data, which are largely used, growing strongly, with great market value, but also completely elusive and totally unrecognized to the individual.

Ultimately therefore the present invention solves problems of security, tracking and reconstruction of the digital life of each user who browses the web using a suitable device, for example a smartphone, a tablet, a computer or suchlike and allows to valorize the digital data transmitted by each user.

In other words, the present architecture therefore allows to obtain the first and the only complete repository of everyone's digital life, that is, Digital Identity+Behavior. It is always available to the individual member or user, in a private and protected form, for any need.

The present architecture also allows the reconciliation and effective grouping of data, in an ecosystem that, as of today, sees the data of all of us lost in thousands of streams and repositories, with no possibility of control or intervention; it also allows a real control, reduction and redirection of communication noising and “pollution” from overexposure—nowadays totally uncontrolled—by the individual, in the quantity and in the manner defined by him/her.

The present architecture obtains, for the first time, the economic valorization of the individual's data, giving him/her concretely and operationally the protagonist role established by old and new laws and codes (for example European law 679/2016 GDPR which is currently in force in 28 countries, but see also the drafts of the new ePrivacy regulation), guaranteeing and concretely obtaining, for the individual, the right to an economic return.

On the user/client side of the data (Advertisers, Companies, Media Centers), this architecture obtains for the first time a concrete optimization mechanism (waste reduction, greater precision and correct and direct dialogue with the real potential market) and systemic sharing of the economic value, in an unprecedented win-win-win flow and with innovative and huge advantages in image and economic return.

It is clear that modifications and/or additions of parts can be made to the architecture and method for tracking and managing digital data as described heretofore, without departing from the field and scope of the present invention.

It is also clear that, although the present invention has been described with reference to some specific examples, a person of skill in the art shall certainly be able to achieve many other equivalent forms of architecture and method for tracking and managing digital data, having the characteristics as set forth in the claims and hence all coming within the field of protection defined thereby.

In the following claims, the sole purpose of the references in brackets is to facilitate reading: they must not be considered as restrictive factors with regard to the field of protection claimed in the specific claims.

1. Architecture for tracking and managing digital data, in particular digital data deriving from browsing the World Wide Web and/or also supplied or exchanged off-line with bodies such as service providers or other, by one or more users through interactions that tend to be mediated by connection instruments such as cards or suchlike, and/or one or more browsing devices (12), such as smartphones, tablets, personal computers or suchlike, equipped with a corresponding browser, said architecture being wherein it comprises:
at least one app or interface (11) configured to be loaded on said browsing device (12) and in which the tracking and management of the digital data transmitted by one or more of said browsing devices (12) is performed, said tracking being carried out by a Webtracker app or by a proprietary Identification Number;
at least one management platform (13) provided with a centralized server able to receive the digital data transmitted by said one or more browsing devices (12) or the digital data transmitted by third party bodies such as service providers or other;
at least one memory system (16) to memorize the digital data, able to communicate with the centralized server of the management platform (13) and with said one or more browsing devices (12) and to allow to collect, organize, protect and make anonymous the digital data, and also to file and reconstruct the chronology or digital life of one or more users, each user being enabled to access the architecture and hence his/her own digital life thanks to the access of the browsing device in his/her possession to said centralized server by means of said interface (11);
at least a data masking app (13) operatively communicating with said management platform (13) and said interface (11).

2. Architecture as in claim 1, wherein said memory system (16) of the digital data is associated with a backend app.

3. Architecture as in claim 1, wherein said memory system (16) comprises a first protected database (3B) for filing sensitive data, and a second database (3A) for filing data able to be distributed and shared by the centralized server.

4. Architecture as in claim 1, wherein said data masking app (13) comprises an algorithm for encrypting the digital data transmitted by each user, so that each user is guaranteed confidentiality of the digital data transmitted, that is, a data protection tool.

5. Architecture as in claim 1, wherein it comprises an Advertising Individual Cancellation tool with an anti-noising&spamming function, that is, an individual advertising blocker request targeted to specific communications and/or specific origins.

6. Architecture as in claim 1, wherein it comprises an Advertising Lock&Locker tool, based in particular on the proposal and consequent completely voluntary acceptance of communications, offers and automatic feedback.

7. Architecture as in claim 1, wherein it comprises an Advertising&Product Feedback tool, that is, a form of sharing digital data with Companies that produce goods, for consultancy and information purposes, in particular for publicity of products and offers in specific sections of the community.

8. Architecture as in claim 1, wherein it comprises a sharing tool configured to allow communication between several devices and hence several users of the architecture, in particular in social connection logistics.

9. Architecture as in claim 1, wherein it comprises an automatic Data Value Revendication tool against Third Parties (portability).

10. Method for tracking and managing digital data, in particular digital data deriving from browsing the World Wide Web and/or supplied or exchanged with bodies such as service providers or other by one or more users through one or more browsing devices, such as smartphones, tablets, personal computers or suchlike, equipped with a corresponding browser, said method being wherein it comprises at least a step of tracking the digital data transmitted by one or more of said browsing devices, in particular by using the Identification Number, thus tracking the users of the architecture; at least a step of receiving, in parallel and by a centralized server, the digital data transmitted by said one or more browsing devices; at least a step of memorizing the digital data received by the centralized server and of reconstructing the chronology or digital life of one or more users, each user being able to access his/her own digital life thanks to the access of the browsing device in his/her possession to said centralized server.
